(19) United States
(12) Patent Application Publication
(10) Pub. No.: US 2010/0196649 A1
(43) Pub. Date: Aug. 5, 2010

(54) Method of refurbishing recycle disc

(76) Inventors: Troy Tennis, Hastings, MN (US); John W. Wheeler, Cottage Grove, MN (US)

Correspondence Address: Troy Tennis, 705 West 31st Street, Hastings, MN, 55033, US

(21) Appl. No.: 12/653,333

(22) Filed: Dec. 11, 2009

Related U.S. Application Data
(60) Provisional application No. 61/201,535, filed on Dec. 12, 2008.

(51) Int. Cl. B32B 43/00; B32B 25/04

(52) U.S. Cl. 428/63; 156/94

(57) ABSTRACT

A novel method for refurbishing a rubber disc used in a recycle machine comprises the steps of cleaning and sanding the surface of the disc; priming at least the surface of the disc with a liquid primer or interfacing agent (adhesive); placing the disc in a portion of a mold; charging or filling the mold with a polymer (synthetic rubber or elastomer) mixed with a suitable catalyst, hardener or activator; allowing the synthetic rubber polymer to exothermally cure inside the mold; and withdrawing the disc from the mold. The resulting refurbished disc is characterized by a new outer surface layer (synthetic rubber) adhered to the original rubber disc. In an alternatively preferred method, one or more relatively small holes are formed in the surface of the disc prior to molding the new outer surface layer on the disc whereupon the strength of the bond between the new outer layer and the original disc is enhanced.

### CROSS-REFERENCE TO RELATED APPLICATION

This application claims priority based upon our copending Provisional Application Ser. No. 61/201,535; filed Dec. 12, 2008.

### BACKGROUND OF THE INVENTION

1. Field of the Invention

The present invention relates generally to a novel method of refurbishing rubber discs and, more particularly, to a novel method of refurbishing the rubber discs used in recycling machines.

2. Description of the Prior Art

Recycle machines having screens to separate (sift) different types and sizes of materials or debris being recycled are well known in the art. In the patent to Austin et al, U.S. Pat. No. 5,960,964, incorporated herein by this reference, there is disclosed a commercially successful recycle machine of the foregoing type featuring multiple rows of rubber discs mounted on corresponding multiple rotating shafts. As disclosed by Austin et al, FIGS. 3-5, the rubber discs may have different shapes or profiles, e.g. triangular, 4-sided or 5-sided, and may be of either unitary or two-piece design with the latter being assembled together when fastened to its respective rotating shaft. After prolonged use, these rubber discs becomes worn and pitted, eventually needing to be replaced. Until the present invention, it was common to replace the rubber discs with newly manufactured versions and throw the old discs away in the manner of discarded automobile tires. The present invention avoids the expense and adverse environmental impact of installing new rubber recycle machine discs by refurbishing worn discs suitably for reuse. The cost of doing so is substantially less than manufacturing new replacement rubber discs, and importantly, the need to treat the worn discs as waste is obviated. Heretofore, used recycle disks had no value and merely were discarded. As a result of the present invention, used or worn recycle discs may be refurnished and thus now have an inherent “core value.”

The foregoing desired advantages over the prior art are achieved by the novel method of the present invention as will be made apparent from the following description thereof. Other advantages of the present invention over the prior art also will be rendered evident.

### SUMMARY OF THE INVENTION

To achieve the foregoing and other advantages, the present invention, provides a novel method for refurbishing a rubber disc used in a recycle machine. The method, briefly described, consists of the steps of cleaning and sanding the surface of the disc; priming at least the surface of the disc with a liquid primer, adhesive or interfacing agent; placing the disc in a portion of the mold; charging or filling the mold with a polymer (synthetic rubber or elastomer) mixed with a suitable catalyst, hardener or activator; allowing the synthetic rubber polymer to exothermally cure inside the mold; and withdrawing the disc from the mold. The resulting refurbished disc is characterized by a new outer surface layer (elastomeric rubber) adhered to the original rubber disc. The new outer layer comprises the cured polymer (synthetic rubber) and gives the refurbished disc the desired durometer and excellent abrasion resistance. Application of this method is far less expensive than the cost of manufacturing new rubber recycle discs. Hence, by use of this method, the refurbished disc may be reused in the recycle machine in which it was originally installed and the waste and adverse environmental impact of throwing away the worn discs is avoided. Moreover, used or worn recycle discs now may be refurnished and thus now have an inherent “core value” whereas as previously (before this invention) such articles were worthless.

In an alternatively preferred method, one or more relatively small holes are formed in the surface of the disc as by drilling before the step of applying the polymer making up the new outer surface layer whereupon the bond between the new outer layer (synthetic rubber) and the original disc is enhanced. When using the holes of the alternatively preferred method, the primer step may or may not be dispensed with.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved method for refurbishing the rubber discs used on a recycle machine.

It is a further object of the present invention to provide a new and improved method of refurbishing the rubber discs originally used on a recycle machine thereby reducing the cost of maintaining and operating the machine over its useful lifetime.

An even further object of the present invention is to provide a new and improved method of refurbishing the rubber discs originally used on a recycle machine thereby avoiding contamination of the environment by treating the original rubber discs as waste.

It is still another object of the present invention to provide a new and improved method of refurbishing the original rubber discs on a recycle machine so that the original discs suitably may be reused.

Yet still a further object of the present invention is to provide a new and improved method of refurbishing the rubber discs originally used on a recycle machine comprising the steps of cleaning and sanding the surface of the disc; priming at least the surface of the disc; placing the disc in a suitable mold; charging or filling the mold with a polymer (synthetic rubber or elastomer) mixed with a suitable catalyst, hardener or activator; allowing the polymer to exothermally cure inside the mold; and withdrawing the disc from the mold.

It is yet still another object of the present invention is to provide a new and improved method of refurbishing the rubber discs originally used on a recycle machine comprising the steps of cleaning and sanding the surface of the disc; drilling one or more holes in the surface of the cleaned disk; priming the surface of the disc; placing the disc in a suitable mold; charging the mold with polymer (synthetic rubber or elastomer) mixed with a suitable catalyst, hardener or activator; allowing the polymer to exothermally cure inside the mold; and withdrawing the disc from the mold.

An even further object of the present invention is to provide a new and improved method of refurbishing the rubber discs originally used on a recycle machine comprising the steps of cleaning and sanding the surface of the disc; drilling one or more holes in the surface of the cleaned disk; placing the disc in a suitable mold; charging the mold with a polymer (synthetic rubber or elastomer) mixed with a suitable catalyst, hardener or activator; allowing the polymer to exothermally cure inside the mold; and withdrawing the disc from the mold.

Yet still another object of the present invention is to refurbish a used rubber recycle disc with a new outer layer of synthetic rubber having a desired durometer.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a flow chart setting forth the preferred sequence of steps in the novel method of the invention for refurbishing a recycle disc.

FIG. 2 is a schematic depiction of a sanding machine used to prepare the surface of a used rubber recycle disc part prior to being processed in accordance with the method of the present invention.

FIG. 3 schematically illustrates the step of priming the surface of the sanded, prepared used disc part of FIG. 1 in accordance with the method of the present invention.

FIG. 4 schematically depicts the step of mounting the disc part of FIG. 1 in a mold section in accordance with the method of the present invention.

FIG. 5 schematically depicts the pouring of an uncured polymer into other mating section of the mold of FIG. 4 in accordance with the method of the present invention.

FIG. 6 schematically illustrates the step of curing the polymer in the mated sections of the mold sections of FIGS. 4 and 5.

FIG. 7 is a schematic depiction of the refurbished recycle disc part of FIG. 1 after it has been withdrawn from the mold partially fragmented (broken away) to show the outer layer of synthetic elastomeric polymer bonded to the inner core member of rubber in accordance with the method of the present invention.

FIG. 8 is a perspective view of the used rubber recycle disc part showing it in accordance with an alternatively preferred method wherein one or more holes are formed (as by drilling) in the surface of the disc prior to being primed as in FIG. 3.

FIG. 9 is a cross-sectional view taken along line 9-9 in FIG. 8.

### DESCRIPTION OF THE PREFERRED EMBODIMENT

With reference to the drawings, the new and improved method of refurbishing a recycle machine rubber disc in accordance with the principles and concepts of the present invention now will be described.

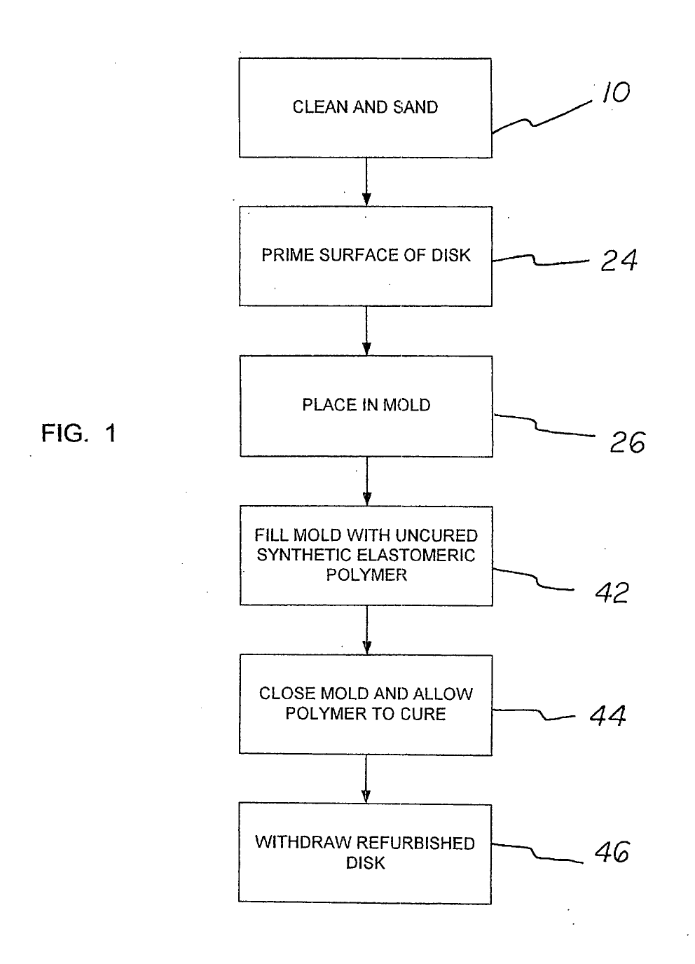

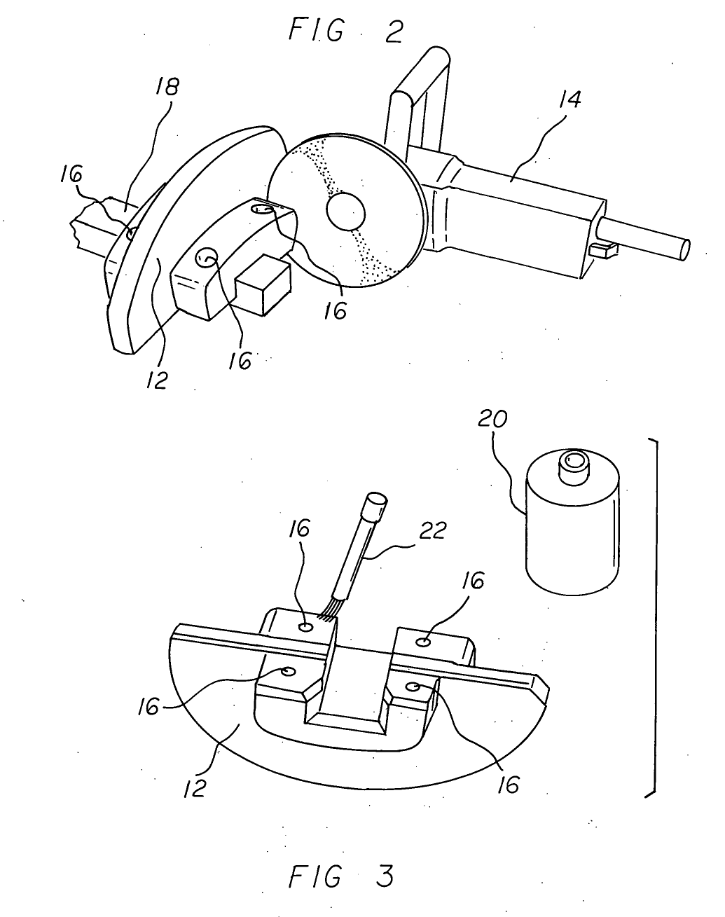

Turning to FIG. 1, the novel method of the invention, has as its initial step 10 the preparation of the surface of the disc being refurbished. Turning next to FIG. 2, this first or preparation step can include sanding the surface of a disc portion 12 with a conventional electrical sanding machine 14. Also, prior to sanding the surface of disc portion 12, the disc surface may be pressure-washed (not shown). The rubber disc portion 12 shown in FIG. 2 can be one-half of a 2-piece disc design and has openings 16 for bolt fasteners so that it may be assembled to another like disc part when fastened about a shaft, for example, in a recycle machine according to the aforementioned '964 patent. To facilitate the sanding operation, the disc portion 12 may be supported on a suitable support block 18. Preferably, the sanding operation is carried out in such a way as to impart a roughened surface to the original disc part. This may be accomplished by using an extremely coarse sanding paper or wheel as will be appreciated by those of ordinary skill in this art. The roughened, clean outer surface of the original disc part will facilitate adhering to a new outer layer of synthetic rubber as will be described subsequently below.

Referring now to FIG. 3, after the rubber disc part 12 has been cleaned and has a roughened sanded outer surface, it is coated with a suitable liquid primer 20. In this step 24 (FIG. 1), the liquid primer preferably is applied to the entire surface of disc part 12 by means of a suitable application brush 22 substantially as depicted. The primer will serve as interfacing agent (adhesive) between the cleaned, sanded rubber surface and a polymeric synthetic rubber or elastomeric component to be subsequently applied as will be further explained below. A suitable liquid primer is commercially distributed by Fusion Systems, Atlanta, Ga., under the designation “CP-GRM Fusion Rubber To Metal Primer” and is mostly preferred.

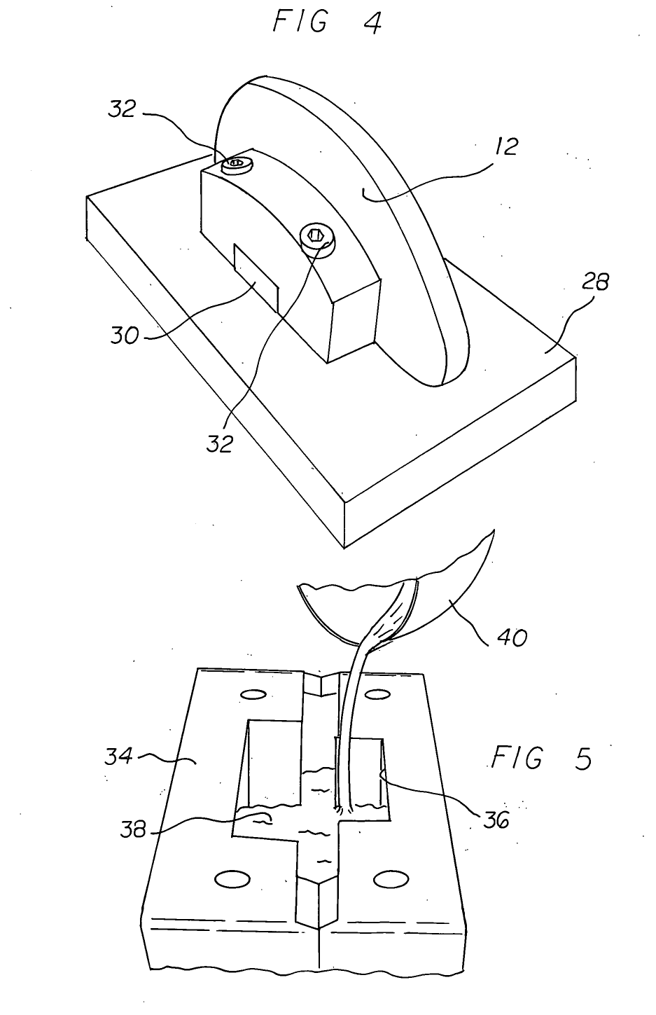

As schematically shown in FIG. 4, the next step 26 (FIG. 1) comprises mounting the primed rubber disc part 12 in a suitable mold section 28 which has a mounting block 30 for supporting the disc part. The rubber disc part is fixed on its support block preferably by bolt fasteners 32 extending through openings 16 substantially as illustrated.

Referring to FIG. 5, another mating mold section 34 is provided defining a cavity 36 suitably sized and configured to accommodate the disc part 12 when the two mold sections 28, 34 are mated together subsequently. The clearance space between the interior walls of cavity 36 and the disc part 12 when the mold sections are mated is sufficient to define the thickness of a polymeric layer to be formed (molded) about the disc part 12 as will be explained further.

Before mating the two mold sections 28, 34, the cavity 36 is suitably charged with a quantity of a liquid 38 preferably poured from a vessel 40 substantially as illustrated (step 42, FIG. 1). Optionally, the two sections of the mold may be fastened together and the liquid 38 suitably injected into the cavity inside the closed mold surrounding the disc part 12 mounted therein.

In accordance with the invention, the liquid 38 is selected from the group consisting of synthetic elastomeric polymers or polyols. A mostly preferred synthetic elastomeric polymer useful for carrying out the present invention is a polyurethane (polyol) adapted to exothermally cure in a mold when mixed with a suitable activator, hardener or catalyst. A suitable polymer is commercially distributed by Utah Foam Products, Salt Lake City, Utah, under the trademark AQUACAST and is mostly preferred. A suitable hardener is isocyanate from the same company and also is mostly preferred. In carrying out the method of the present invention, the hardener (isocyanate) may be mixed with the polyol in a ratio of about 3 parts polyol to 1 part isocyanate to make the liquid mixture 38. As mentioned above, optionally, the liquid polyol mixture may be injected into the mold using a multi-component meter/mix machine, or a reaction injection molding machine (RIM) as is well known in the polymer molding art.

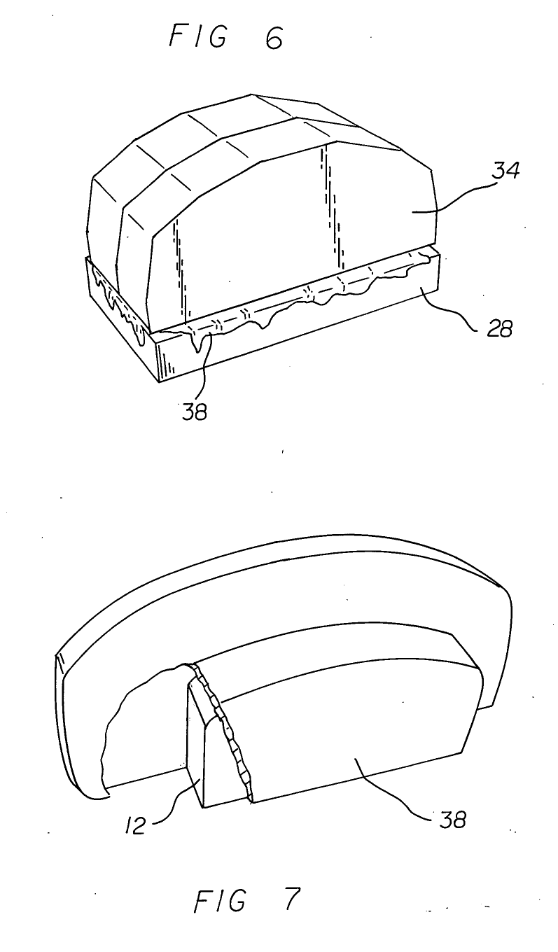

Thus, referring to FIG. 6 there is schematically shown the two sections of the mold 28, 34 mated together with the synthetic elastomeric polymer effluent 38 after a suitable cure time has elapsed (Step 44, FIG. 1). As the polymer cures, it forms a layer of predetermined thickness securely bonded to the outer surface of the rubber disc part 12 inside the mold. Using a mold at room temperature, mold cure time may be in the range of about 30 minutes to about an hour, with a mold time of about 45 minutes being mostly preferred. Heating the mold will generally reduce mold/cure times.

After suitable time has elapsed to achieve cure, the mold is opened and the refurbished disk withdrawn and trimmed (Step 46, FIG. 1). The resulting article is diagrammatically illustrated in FIG. 7. There it can be seen that the refurbished disc part comprises an inner core (original rubber disc part 12) and an outer surface layer or covering of cured synthetic polymer 38 (i.e polyurethane) bonded to the inner rubber core. This refurbished disc part has a desired durometer and excellent abrasion resistance with a longer operational life than rubber.

An important feature of the present invention is the discovery that by using a synthetic elastomeric polymer as an outer layer bonded to a rubber core it is possible to vary the durometer of the outer layer by adjusting the ratio of hardener to polyol in the mixture 38, or selecting a specific synthetic rubber polymer. As a result, different refurbished discs having different specific desired durometers, respectively, advantageously may be produced for use in a recycle machine in different positions to control the sifting of different materials. Additionally, refurbished discs may be produced having a desired durometer suitable for a particular environmental application. For example, in recycle machines employed in cold climate regions, it would be desirable to have a refurbished disc of relatively low durometer to compensate for the effect a “cold” ambient temperature would have tending to raise or increase the durometer of the disc's outer layer.

The “durometer” of a rubber or synthetic rubber is a measure of its hardness. For example, a Shore A 30 durometer would be a rubber band; a Shore A 40 durometer a pencil erasure; and a Shore A 60 durometer an automobile tire. Refurbished discs made in accordance with the present invention generally have a durometer of about Shore A 50, but may be varied, as mentioned above, by selecting a particular polymer or varying the ratio of activator (isocynate) to polyol in the of mixture 38, both. Generally, an increase in the ratio of activator/polyol will result in lowering the durometer of the resulting article and vice versa.

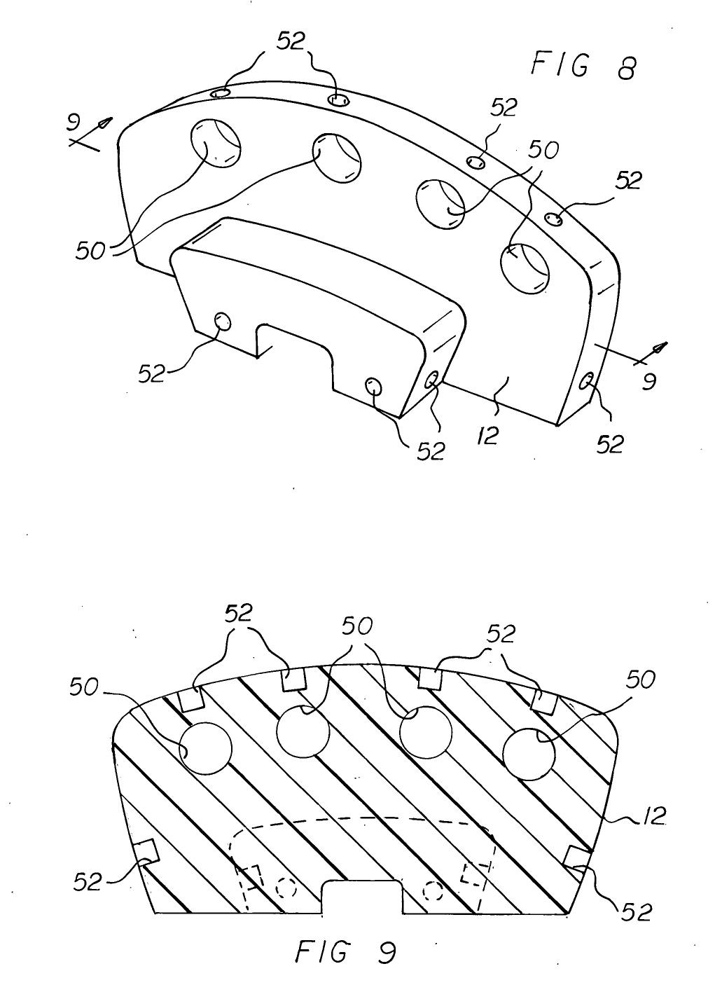

In accordance with an alternatively preferred method of the invention, before priming the surface of the previously cleaned and sanded disc part (FIG. 3), one or more small holes optionally may be formed in the formed in surface of disc portion 12. This is schematically shown in FIGS. 8 and 9, where it will be observed a first series of “through” holes 50 are formed extending completely through disk portion 12 and a second series of “blind” holes 52 are formed extending partially into the edge or edges of disc portion 12, substantially as depicted. During the molding step it will be appreciated that the exothermally curable liquid polymer seeps into and completely fills holes 50 and 52 providing increased surface area between the bonding layer and the disc portion 12 and thereby enhancing the security of the bond between the cured outer layer 38 and the outer surface of the original rubber disc part 12. By using the holes 50, 52, the “primer” step (FIG. 3) may be omitted. Alternatively, both the primer step and the alternative provision of holes 50, 52 may be used in combination to achieve maximum bonding strength between the new outer layer and original rubber disc.

The foregoing detailed description is considered as illustrative only of the principles of the invention. Numerous modifications and changes will readily occur to those skilled in the art and therefore, it is not desired to limit the invention to the exact construction and operation shown and described. Accordingly, all suitable modifications and equivalents falling within the broad scope of the subject matter described above may be resorted to in carrying out the present invention.

With the present invention, rubber discs of the type disclosed in Austin et al (No. 5,960,964), FIGS. 3-5, no longer have to be discarded after they have become worn and pitted following prolonged use. The novel methods of the present invention avoid the expense of installing new rubber discs, avoid the adverse environmental impact of discarding the used discs, and add inherent “core value” to the used recycle discs, thereby constituting an important and significant contribution to the art of recycle machines.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A method for refurbishing a rubber disc used as a rotatable separator member in a recycle machine, comprising the following steps:
(a) removing the disc from said recycle machine,
(b) bonding a layer of polyurethane on the outer surface of the disc removed from the recycle machine in step (a).

2. The method of claim 1 wherein said step (b) comprises the additional steps of:
(c) priming the surface of the disc of step (a) with an interfacing agent,
(d) mounting the disk of step (a) in a mold,
(e) pouring a liquid polyurethane into said mold, and
(f) exothermally curing said polyurethane in said mold for a predetermined period of time.

3. The method of claim 2 wherein said step (e) comprises the additional steps of (g) mixing said liquid polyurethane together with a hardener in the ratio of about 3 parts polyurethane to about 1 part hardener before pouring said mixture into said mold.

4. The method of claim 1 comprising the additional step of forming one or more holes in the surface of the disc of step (a) prior to step (b).

5. The method of claim 2 comprising the additional step of forming one or more holes in the surface of the disc of step (a) prior to step (c).

6. The method of claim 4 wherein said step of forming one or more holes comprises the step of forming at least one through hole in the disk of step (a).

7. The method of claim 6 wherein the step of forming one or more holes comprises the additional step of forming at least one blind hold in the disk of step (a).

8. The method of claim 5 wherein said step of forming one or more holes comprises the step of forming at least one through hole in the disk of step (a).

9. The method of claim 8 wherein the step of forming one or more holes comprises the additional step of forming at least one blind hold in the disk of step (a).

10. The method of claim 2 wherein said step (f) of exothermally curing said polyurethane in said mold for a predetermined period of time has a duration of about 45 minutes and said mold is held at room temperature before said duration commences.

11. The refurbished disc produced by the method of claim 1.

12. The refurbished disc produced by the method of claim 2.

13. The refurbished disc produced by the method of claim 3.

14. The refurbished disc produced by the method of claim 4.

15. The refurbished disc produced by the method of claim 5.

16. The refurbished disc produced by the method of claim 6.

17. The refurbished disc produced by the method of claim 7.

18. The refurbished disc produced by the method of claim 8.

19. The refurbished disc produced by the method of claim 9.

20. The refurbished disc produced by the method of claim 10.
